(19) United States
(12) Patent Application Publication
(10) Pub. No.: US 2008/0064229 A1
(43) Pub. Date: Mar. 13, 2008

(54) Connector with high connection reliability

(75) Inventor: Takashi Tokunaga, Tokyo (JP)

Correspondence Address: WILLIAM COLLARD;COLLARD & ROE, P.C., 1077 NORTHERN BOULEVARD, ROSLYN, NY, 11576, US

(73) Assignee: JAPAN AVIATION ELECTRONICS INDUSTRY, LIMITED

(21) Appl. No.: 11/900,371

(22) Filed: Sep. 11, 2007

(30) Foreign Application Priority Data
Sep. 12, 2006 (JP) 2006-246768

(51) Int. Cl. H01R 12/00

(52) U.S. Cl. 439/59

(57) ABSTRACT

In a connector adapted for connection to a mating connector, each contact includes a holding portion held by the housing, a contact receiving portion extending from the holding portion and adapted to contact a contact portion of a corresponding one of contacts of a mating connector, a spring portion extending from the contact receiving portion and movable relative to the housing, and a contact portion provided at the spring portion and adapted to contact a contact receiving portion of the corresponding contact of the mating connector. The housing includes accommodating portions accommodating therein at least portions of the contact receiving portions of the contacts, respectively, and guide portions adapted to guide the contact portions of the contacts of the mating connector toward the accommodating portions, respectively.

This application claims the benefit of priority from Japanese patent application No. 2006-246768, filed on Sep. 12, 2006, the disclosure of which is incorporated herein in its entirety by reference.

### BACKGROUND OF THE INVENTION

This invention relates to a connector including a housing and contacts coupled thereto and further relates to a connecting device using such a connector.

An example of this type of connector is disclosed in Japanese Patent Application Publication (JP-B) No. H05-7829. The connector will be described with reference to FIG. 1.

FIG. 1 is an exemplary diagram showing the behavior of contacts 42 and 52 in a fitting operation, from its beginning to end, between two connectors 41 and 51. Central axes 43 and 53 of the contacts 42 and 52 are aligned with each other.

In the beginning of the fitting operation of the connectors 41 and 51, circular-arc contact points 42a and 52a of the contacts 42 and 52 move in sliding contact with each other and ride over each other as shown at (a) to (c) in FIG. 1.

As shown at (d) in FIG. 1, as the fitting operation of the connectors 41 and 51 progresses, the contact point 42a and the contact point 52a move in sliding contact with each other along an inclined contact surface 52b1 of the contact 52 and an inclined contact surface 42b1 of the contact 42, respectively. Following the movement, elastically deformable portions 42b and 52b respectively having the contact points 42a and 52a are displaced against their respective elastic forces. In this event, because of the presence of the inclined contact surfaces 42b1 and 52b1, concentration of loads on fixed portions 42c and 52c of the contacts 42 and 52 to cause deformation thereof is prevented.

Finally, as shown at (e) in FIG. 1, the contact point 42a and the contact point 52a ride over and elastically contact a flat contact surface 52b2 and a flat contact surface 42b2, respectively.

This type of connector is also disclosed, for example, in Japanese Patent (JP-B) No. 2871128 or Japanese Unexamined Patent Application Publication (JP-A) No. 2005-5158.

### SUMMARY OF THE INVENTION

In the foregoing connectors, although the contact points of the contacts are each formed circular-arc shaped, there is no particular means for avoiding collision between the tips of the contacts at the time of the fitting and there is also no particular means for guiding the tips of the contacts. Further, when the contacts are arranged at a narrow pitch, the connection between the connectors is unstable due to occurrence of pitch deviation.

It is therefore an exemplary object of this invention to provide a connector that facilitates fitting to a mating connector by guiding the tips of contacts and still has high connection reliability.

Other objects of the present invention will become clear as the description proceeds.

According to an exameplarly aspect of the present invention, there is provided a connector adapted for connection to a mating connector, comprising a housing and a contact coupled to the housing, wherein the contact comprises a holding portion held by the housing, a contact receiving portion extending from the holding portion and adapted to contact a portion of the mating connector, a spring portion extending from the contact receiving portion and movable relative to the housing, and a contact portion provided at the spring portion and adapted to contact another portion of the mating connector, wherein the housing comprises an accommodating portion accommodating therein at least a portion of the contact receiving portion and a guide portion adapted to guide the portion of the mating connector toward the accommodating portion.

According to an exameplarly aspect of the present invention, there is provided a connecting device comprising a pair of mutually connectable connectors, wherein each of the pair of connectors comprises a housing and a contact coupled to the housing, wherein the contact comprises a holding portion held by the housing, a contact receiving portion extending from the holding portion, a spring portion extending from the contact receiving portion and movable relative to the housing, and a contact portion provided at the spring portion, wherein the contact receiving portion is adapted to contact the contact portion of the contact of the mating connector in the pair of connectors, wherein the contact portion is adapted to contact the contact receiving portion of the contact of the mating connector, wherein the housing comprises an accommodating portion accommodating therein at least a portion of the contact receiving portion and a guide portion adapted to guide the contact portion of the contact of the mating connector toward the accommodating portion.

### BRIEF DESCRIPTION OF THE DRAWINGS

FIG. 1 is an exemplary diagram showing the behavior of contacts in a fitting operation, from its beginning to end, between connectors of the related art;

FIG. 2A is a perspective view of a plug connector in a connecting device according to an exemplary embodiment of this invention;

FIG. 2B is an exploded perspective view of the plug connector shown in FIG. 2A;

FIG. 3A is a perspective view of a receptacle connector in the connecting device;

FIG. 3B is an exploded perspective view of the receptacle connector shown in FIG. 3A;

FIG. 4A is an enlarged half sectional view showing a state before the fitting of the plug connector and the receptacle connector of the connecting device;

FIG. 4B is an enlarged half sectional view showing a state after the fitting of the plug connector and the receptacle connector of the connecting device; and

FIG. 5 is a perspective view showing only a main part of the receptacle connector shown in FIG. 3A.

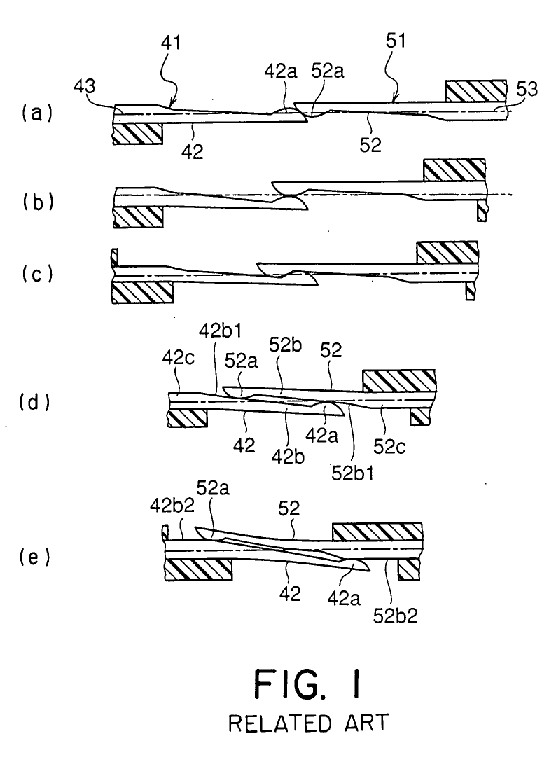

### DESCRIPTION OF THE PREFERRED EMBODIMENT

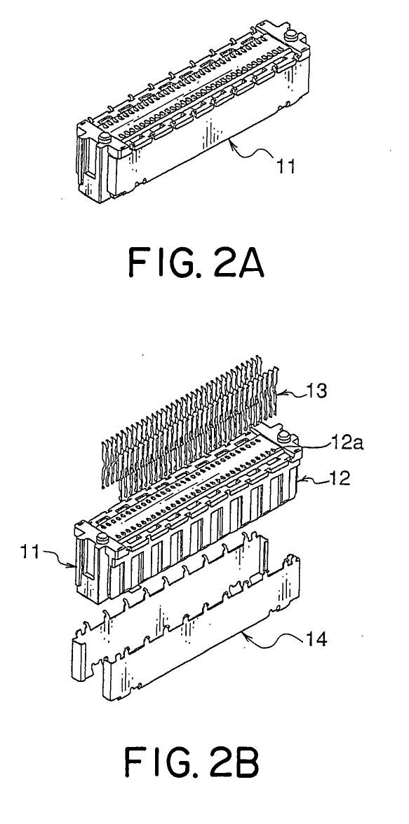

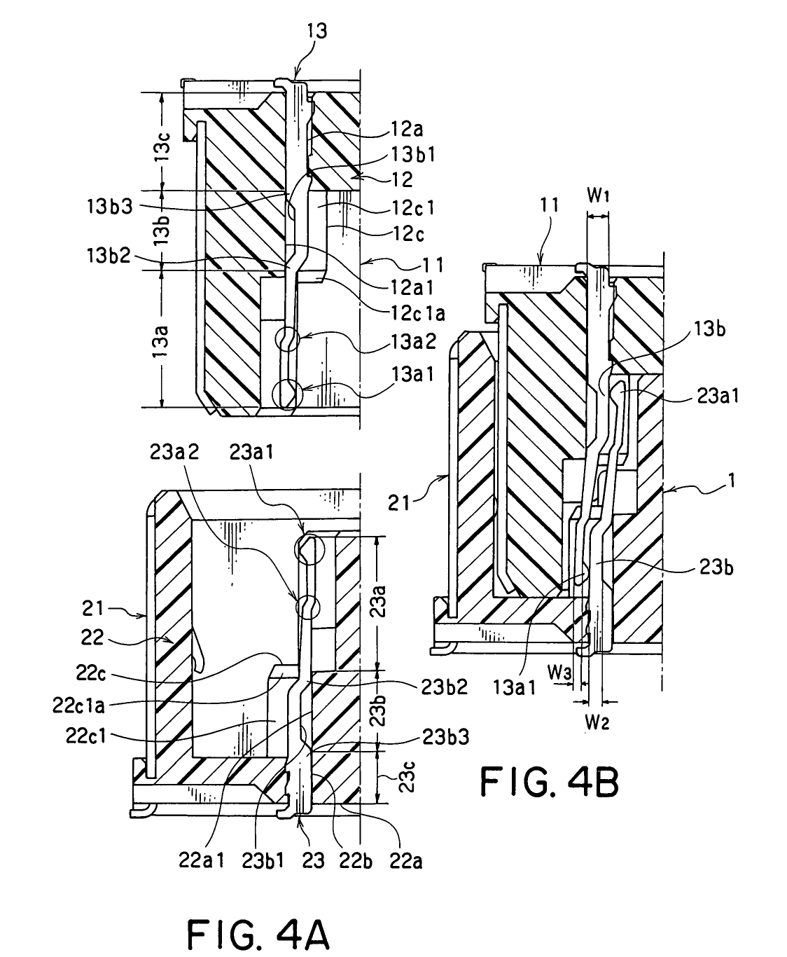

Referring to FIGS. 2A to 5, description will be given of a connecting device according to an exemplary embodiment of this invention. The connecting device is depicted by reference numeral 1 in FIG. 4B and comprises a plug connector 11 and a receptacle connector 21 fitted thereto.

In FIGS. 2A and 2B, the plug connector 11 includes a plug-side insulator (housing) 12. In the middle of the plug-side insulator 12, a large number of pairs of contact holding holes 12a are provided in two rows at a predetermined pitch. A large number of pairs of plug-side contacts 13 are inserted into the large number of pairs of contact holding holes 12a, respectively, so as to be held. Four sides of the plug-side insulator 12 are covered with a pair of plug-side shells 14.

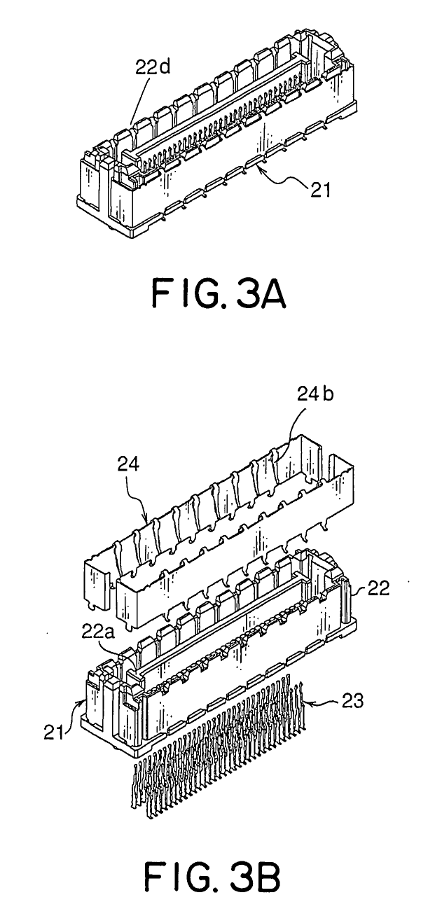

In FIGS. 3A and 3B, the receptacle connector 21 includes a receptacle-side insulator (housing) 22. In the receptacle-side insulator 22, a large number of pairs of contact holding holes 22b (see FIG. 4A) are provided in two rows at the predetermined pitch on both sides of a middle partition wall 22a. A large number of pairs of receptacle-side contacts 23 are inserted into the large number of pairs of contact holding holes 22b, respectively, so as to be held. Four sides of the receptacle-side insulator 22 are covered with a pair of receptacle-side shells 24.

The receptacle-side shells 24 have a plurality of spring contact portions 24b adapted to contact the plug-side shells 14. The receptacle-side insulator 22 has a plurality of grooves 22d for insertion of the spring contact portions 24b.

FIG. 4A shows a state before the fitting of the plug connector 11 and the receptacle connector 21.

The plug-side contacts 13 are each integrally formed by a spring portion 13a, a contact receiving portion (intermediate portion) 13b, and a holding portion (press-fitting portion) 13c held by the plug-side insulator (housing) 12.

The spring portion 13a has at its tip a contact portion 13a1 adapted for connection to a contact receiving portion 23b of the corresponding receptacle-side contact 23, and a crank portion 13a2 in the middle thereof.

Except one end adjacent to the spring portion 13a and the other end adjacent to the holding portion 13c, the contact receiving portion 13b is partly omitted on its side opposite to its side adapted for connection to a contact portion 23a1 of the corresponding receptacle-side contact 23 so as to have a narrow width about half the width of the holding portion 13c. In other words, the contact receiving portion 13b has a shallow concave portion 13b1 facing a bottom wall 12a1 of the contact holding hole 12a with a space therebetween, and abutting portions 13b2 and 13b3 abutting against the bottom wall 12a1 on both sides of the concave portion 13b1.

Similarly, the receptacle-side contacts 23 are each integrally formed by a spring portion 23a, the contact receiving portion (intermediate portion) 23b, and a holding portion (press-fitting portion) 23c held by the receptacle-side insulator (housing) 22.

The spring portion 23a has at its tip the contact portion 23a1 adapted for connection to the contact receiving portion 13b of the corresponding plug-side contact 13, and a crank portion 23a2 in the middle thereof.

Except one end adjacent to the spring portion 23a and the other end adjacent to the holding portion 23c, the contact receiving portion 23b is partly omitted on its side opposite to its side adapted for connection to the contact portion 13a1 of the corresponding plug-side contact 13 so as to have a narrow width about half the width of the holding portion 23c. In other words, the contact receiving portion 23b has a shallow concave portion 23b1 facing a bottom wall 22a1 of the contact holding hole 22b with a space therebetween, and abutting portions 23b2 and 23b3 abutting against the bottom wall 22a1 on both sides of the concave portion 23b1.

Further, as shown in FIG. 4B, given that the width of each of the holding portions 13c and 23c is W1, the width of each of the contact receiving portions 13b and 23b is W2, and the width of each of the spring portions 13a and 23a is W3, a design is made to satisfy a relationship of W2+W3≦W1. That is, the dimensions of the respective portions are designed so that the sum of the width of the contact receiving portion and the width of the spring portion is no greater than the width of the holding portion. This makes it possible to uniformize or equalize the impedances at the respective portions at the time of the connection between the connectors, thereby achieving excellent impedance matching. Therefore, it is possible to provide the connecting device excellent in high-frequency transmission.

FIG. 4B shows a state after the fitting of the plug connector 11 and the receptacle connector 21. In this state, the contact portions 13a1 of the plug-side contacts 13 are connected to the contact receiving portions 23b of the receptacle-side contacts 23, respectively, and the contact portions 23a1 of the receptacle-side contacts 23 are connected to the contact receiving portions 13b of the plug-side contacts 13, respectively.

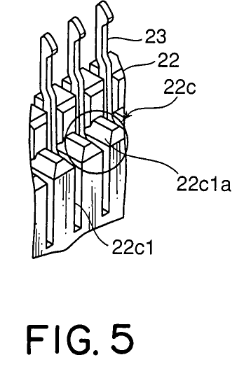

Referring also to FIG. 5 in addition to FIG. 4A, mold walls 22c are formed parallel to and on both sides of the middle partition wall 22a in the lower part of the receptacle-side insulator 22. The mold walls 22c each have the bottom wall 22a1 being part of the middle partition wall 22a.

Each mold wall 22c has a large number of groove-shaped accommodating portions 22c1 accommodating therein at least portions of the contact receiving portions 23b of the large number of receptacle-side contacts 23, respectively. Each accommodating portion 22c1 has at its entrance a tapered guide portion 22c1a adapted to guide the contact portion 13a1 of the corresponding plug-side contact 13 at the time of the fitting.

Mold walls 12c of the plug-side insulator 12 have the same structure as that of the mold walls 22c of the receptacle-side insulator 22. That is, each mold wall 12c also has accommodating portions 12c1 corresponding to the accommodating portions 22c1, guide portions 12c1a corresponding to the guide portions 22c1a, and the bottom wall 12a1 corresponding to the bottom wall 22a1.

As clear from FIG. 4B, each of the contact receiving portions 13b and 23b is adapted to contact the contact portion 23a1 or 13a1 of the mating-side contact on the side opposite to the concave portion 13b1 or 23b1. Therefore, since the contact receiving portions 13b and 23b can also be elastically displaced, the reliability of contact is improved.

Further, since each of the contacts 13 and 23 is held by the abutment of both ends of the concave portion 13b1 or 23b1 of the contact receiving portion 13b or 23b against the bottom wall 12a1 or 22a1 of the accommodating portion 12c1 or 22c1, the position accuracy of the contact receiving portions 13b and 23b is excellent.

Each plug-side contact 13 is provided with the crank portion 13a2 and each receptacle-side contact 23 is provided with the crank portion 23a2. Therefore, at the time of the fitting of the plug connector 11 and the receptacle connector 21, collision between the contact portions 13a1 and 23a1 of the contacts 13 and 23 is avoided and thus the contacts 13 and 23 are prevented from buckling.

In the illustrated example, the holding portions (press-fitting portions) 13c and 23c of the contacts 13 and 23 have mutually different shapes, but may be configured to have the same shape.

Further, by configuring the insulators (housings) 12 and 22 of the connectors 11 and 21 to have the same shape and also the shells 14 and 24 to have the same shape, the connectors 11 and 21 can be configured to be of the hermaphroditic type.

The foregoing connecting device exhibits the following effects.

1. Since the contact portions of the contacts of the connectors are guided by the guide portions of the mating connectors at the time of the fitting, collision between the tips of the contacts of the connectors is avoided and thus the connectors can be smoothly fitted together.

2. Since the connectors can be configured as hermaphroditic-type connectors, the cost is reduced and, further, handling of the connectors is facilitated.

3. The contact receiving portion of each contact is formed into a generally U-shape and both ends of the generally U-shape abut against the bottom wall of the accommodating portion. Therefore, since each contact receiving portion can also be elastically displaced, the reliability of contact is improved. Further, since each contact is held at the predetermined position of the housing, the position accuracy of each contact receiving portion is excellent.

While the present invention has thus far been described in connection with a few embodiments thereof, it will readily be possible for those skilled in the art to put this invention into practice in various other manners.

What is claimed is:

1. A connector adapted for connection to a mating connector, comprising a housing and a contact coupled to the housing,
wherein the contact comprises:
a holding portion held by the housing;
a contact receiving portion extending from the holding portion and adapted to contact a portion of the mating connector;
a spring portion extending from the contact receiving portion and movable relative to the housing; and
a contact portion provided at the spring portion and adapted to contact another portion of the mating connector,
wherein the housing comprises:
an accommodating portion accommodating therein at least a portion of the contact receiving portion; and
a guide portion adapted to guide the portion of the mating connector toward the accommodating portion.

2. The connector according to claim 1, wherein the contact receiving portion is designed to be narrower in width than the holding portion.

3. The connector according to claim 1, wherein the sum of a width of the spring portion and a width of the contact receiving portion is designed to be no greater than a width of the holding portion.

4. The connector according to claim 1, wherein the spring portion has a crank portion at a midway portion between the contact portion and the contact receiving portion.

5. The connector according to claim 1, wherein the accommodating portion has a bottom wall facing the contact receiving portion.

6. The connector according to claim 5, wherein the contact receiving portion comprises:
a concave portion facing the bottom wall with a space therebetween; and
abutting portions abutting against the bottom wall on both sides of the concave portion.

7. A connecting device comprising a pair of mutually connectable connectors, wherein each of the pair of connectors comprises a housing and a contact coupled to the housing,
wherein the contact comprises:
a holding portion held by the housing;
a contact receiving portion extending from the holding portion;
a spring portion extending from the contact receiving portion and movable relative to the housing; and
a contact portion provided at the spring portion,
wherein the contact receiving portion is adapted to contact the contact portion of the contact of the mating connector in the pair of connectors,
wherein the contact portion is adapted to contact the contact receiving portion of the contact of the mating connector,
wherein the housing comprises:
an accommodating portion accommodating therein at least a portion of the contact receiving portion; and
a guide portion adapted to guide the contact portion of the contact of the mating connector toward the accommodating portion.

8. The connecting device according to claim 7, wherein the contact receiving portion is designed to be narrower in width than the holding portion.

9. The connecting device according to claim 7, wherein the sum of a width of the spring portion of the contact of one of the pair of connectors and a width of the contact receiving portion of the contact of the other connector is designed to be no greater than a width of the holding portion.

10. The connecting device according to claim 7, wherein the spring portion has a crank portion at a midway portion between the contact portion and the contact receiving portion.

11. The connecting device according to claim 7, wherein the accommodating portion has a bottom wall facing the contact receiving portion.

12. The connecting device according to claim 11, wherein the contact receiving portion comprises:
a concave portion facing the bottom wall with a space therebetween; and
abutting portions abutting against the bottom wall on both sides of the concave portion.
